(19) United States
(12) Patent Application Publication
(10) Pub. No.: US 2018/0205143 A1
(43) Pub. Date: Jul. 19, 2018

(54) COMPACT WIRELESS MULTIPLANAR COMMUNICATIONS ANTENNA

(71) Applicant: KS CIRCUITS INC., Toronto (CA)

(72) Inventors: Williamson SY, Richmond Hill (CA); Kajendran SELVACHANDIRAN, North York (CA); Yazi CAO, Newmarket (CA)

(21) Appl. No.: 15/743,564

(22) PCT Filed: Jul. 11, 2016
(86) PCT No.: PCT/CA2016/050812

§ 371 Date: Jan. 10, 2018

Related U.S. Application Data
(60) Provisional application No. 62/191,174, filed on Jul. 10, 2015.

(51) Int. Cl. H01Q 1/38; H01Q 1/32; H01Q 1/52

(52) U.S. Cl. CPC H01Q 1/38; H01Q 7/06; H01Q 1/52; H01Q 1/3241

(57) ABSTRACT

There is provided an antenna including a substrate comprising two or more regions, one or more conductive components disposed on the substrate, over two or more of the regions; and, wherein the regions are oriented on or relative to different planes and wherein the planes are substantially spaced from one another, and with the conductive components situated on a first one of the planes being operatively magnetically coupled to non-conductive components situated on an other of the planes.

### FIELD

Antennas for short-range communications, and more particularly to antennas configured to occupy low volumes.

### BACKGROUND

In recent years, the wireless communication market has expanded greatly. Wireless devices such as those used in remote control engine start systems, remote keyless ignition (RKI) systems, remote keyless entry (RKE) systems, automatic tolling systems, etc. are now considered “classical” devices for short-range vehicle wireless communication. In these systems, the antenna is a key component for system performance and size.

The most commonly used antennas for many of these wireless devices are of the helical type including, for example, copper wire wound about a core. However, one drawback of the helical antenna is their mechanical construction and bulky sizes. Also, helical antennas are also easily de-tuned by the nearby objects, including, for example, during processing and/or handling.

One option for addressing at least in part issues of de-turning, cumbersome processing and installation is the use of printed circuit board (“PCB”) antennas. But, traditional PCB antennas require relatively large surface area PCBs. This makes them impractical for devices and applications where size limitation is an issue. This is problematic because in many implementation environments space is increasingly precious, particularly as functions and related infrastructure are added to various devices.

### BRIEF SUMMARY

There is disclosed herein an antenna including a substrate comprising two or more regions, one or more conductive components disposed on the substrate, over two or more of the regions; and, wherein the regions are oriented on or relative to different planes and wherein the planes are substantially spaced from one another, and the conductive components situated on the first one of the planes are magnetically coupled to the conductive components situated on an other of the planes.

In another disclosed aspect, the antenna further comprises an impedance matching zone comprising a capacitor operatively connected to the substrate.

In another disclosed aspect, the conductive components comprise a plurality of segments, wherein each of the segments is electrically connected to at least another of the segments and the conductive components have a total length which is the combined length of the segments.

In another disclosed aspect, one or more of the segments are situated on a first one of the planes and connected to one of the segments situated on another of the planes.

In another disclosed aspect, the segments on the first one of the planes are oriented in substantially the same direction as one another such that current may flow therethrough in the same direction.

In another disclosed aspect, a first one of the segments is provided on the first one of the planes and a second one of the segments is provided on the other one, and wherein the first and second ones of the segments are electrically connected by a conductive element.

In another disclosed aspect, the substrate has a first surface and a second surface opposite thereto, and the other one of the planes is substantially aligned with the second surface, and the first one of the planes is substantially aligned with the first surface.

In another disclosed aspect, the conductive element is not situated on either of the planes and is not integral to the substrate.

In another disclosed aspect, the conductive element comprises one of more of a conductive strip and a conductive clip.

In another disclosed aspect, the non-conductive components are adapted for connection with one or more of a transceiver circuit and a power source.

In another disclosed aspect, the substrate has defined therein a plurality of via-holes extending between an upper surface and a lower surface thereof through which via-holes the segments on the upper surface are electrically connected to those on the lower surface or on an adjacent one of the planes.

In another disclosed aspect, the segments and the conductive elements collectively form an electrical path defining a pattern, and wherein the antenna is adapted for current flow along the path in a direction.

In another disclosed aspect, the pattern comprises a two dimensional spiral pattern.

In another disclosed aspect, the second segment is spaced from the first segment and provided substantially within the pattern.

In another disclosed aspect, the conductive components comprises a plurality of the segments provided in line with a single one of the planes.

In another disclosed aspect, the planes comprises multiple planes, each of the planes having substantially aligned therewith one or more of the conductive components.

In another disclosed aspect, the pattern is substantially repeating on adjacent one of the planes.

In another disclosed aspect, the pattern comprises zigzagging pattern.

In another disclosed aspect, the antenna comprises the segments provided in a double spiral pattern; a capacitive strip having two layers, wherein one of the layers is connected to the non-conductive components, wherein the non-conductive components comprises a ground plane printed on a front side of the substrate board for connection with one or more of a transceiver circuit or a battery.

In another disclosed aspect, the pattern comprises a plurality of double spirals, and wherein each of the double spirals is aligned with and magnetically coupled to the double spiral of another plane.

In another disclosed aspect, each pattern is composed of magnetically coupled pairs of the segments aligned substantially parallel to each other and in the same direction along the path.

There is also disclosed herein an antenna for transmitting a signal, the antenna comprising a substrate comprising two or more regions; one or more conductive components disposed on the substrate, over two or more of the regions; wherein the regions are each oriented in substantial alignment with different planes and wherein the planes are substantially spaced from and substantially parallel to one another; a power source for driving a current in a direction along an electrical path comprised of the conductive components and notionally collectively defined by portions of each of the planes and conductive elements interposed between the regions aligned with the planes; and, wherein the conductive components oriented on each of the planes are magnetically coupled with the conductive components on at least an adjacent one of the planes.

In another disclosed aspect, the antenna further comprises a ferrite sheet substantially contiguous with a surface of the substrate to prevent transmission of the signal towards the sheet.

### BRIEF DESCRIPTION OF THE DRAWINGS

In the drawings:

FIG. 1a is a schematic view of a prior art antenna configuration;

FIG. 1b is a schematic view showing the current flow, at a particular point in time, in the prior art antenna configuration. FIGS. 1a and 1b are collectively referred to as FIG. 1;

FIG. 2a is a schematic view of an antenna configuration according to one embodiment disclosed herein;

FIG. 2b is a schematic view showing the current flow, at a particular point in time, in the antenna configuration shown in FIG. 2a;

FIG. 2c is a schematic view showing a portion of the antenna configuration in

FIG. 2a on a first plane;

FIG. 2d is a schematic view showing a portion of the antenna configuration in FIG. 2a on a second plane;

FIG. 2e is a schematic view showing the path of current flow in the portion of the antenna configuration in FIG. 2c on the first plane;

FIG. 2f is a schematic view showing the path of current flow in the portion of the antenna configuration in FIG. 2d on the second plane; herein, FIGS. 2a to 2f may be collectively referred to as FIG. 2;

FIG. 3a is a top view of a compact antenna according to one embodiment disclosed herein;

FIG. 3b is a perspective view of the compact antenna of FIG. 3a; herein, FIGS. 3a and 3b may be collectively referred to as FIG. 3;

FIG. 4 is a detailed view of a portion of the compact antenna of FIG. 3a;

FIG. 5 is a schematic view of a “looped” compact antenna configuration, according to another embodiment disclosed herein;

FIG. 6a is a schematic view of a configuration having multiple “loops,” according to another embodiment disclosed herein;

FIG. 6b is a schematic view notionally showing the path current flow within each “loop” in different layers according to another embodiment disclosed herein;

FIG. 7a is a schematic cross-sectional view showing one method for connecting antenna segments on different planes;

FIG. 7b is a schematic view showing another method for connecting antenna segments on different planes;

FIG. 8a is a top view of a compact antenna according to another embodiment disclosed herein;

FIG. 8b is a bottom view of the compact antenna of FIG. 8a;

FIG. 9a is a side view of the compact antenna;

FIG. 9b is a side view of the first stacked coils connected through the vias; and

### DETAILED DESCRIPTION

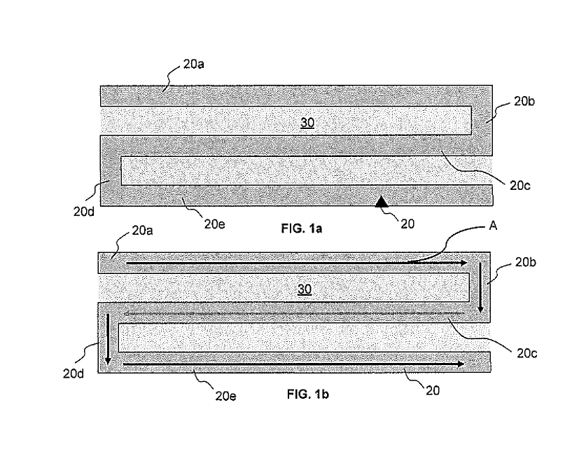

With reference to FIG. 1, a prior art antenna comprises a conductive component 20 that is disposed on one plane 22. The conductive material comprises a number of long antenna segments 20a, 20c, and 20e connected by a number of short antenna segments 20b and 20d. The pattern formed by the conductive material is shown in FIG. 1, wherein the long antenna segments are substantially parallel to one another and substantially perpendicular to the short antenna segments. FIG. 1b shows the current direction in the conductive component, wherein the current direction in adjacent long antenna segments runs parallel but opposite to one another. For example, the current direction in segment 20a is opposite of that in segment 20c.

The present disclosure aims to provide a compact, high performance, low-cost antenna 100 for integration into wireless devices, such as short-range wireless devices, for example those used in remote control engine start systems, remote keyless entry (RKE) systems, remote keyless ignition (RKI) systems, automatic tolling systems, etc. The presently disclosed antenna 100 would also be applicable to other short-range wireless and antenna systems as well as medium and long-range wireless devices. The antenna 100 is capable of receiving or broadcasting a single on multiple bandwidths along the frequency spectrum, which can be selected from any bandwidth, including any those commercially used. The antenna 100 can be constructed and configured to send and/or receive transmissions either passively or actively.

In a broad aspect disclosed herein, there is provided a radio antenna 100 comprising one or more conductive components 120 and, in some embodiments, one or more non-conductive components, disposed on a substrate 50. At least a portion of the conductive component is, in some embodiments, made of flexible material and at least a portion of the flexible conductive component is continuously attached to the one or more non-conductive component. In some embodiments, all or a significant portion of the conductive component is made of flexible material. The non-conductive component may be of a rigid, non-flexible material.

In other embodiments, the conductive components may be substantially rigid once formed to an operative shape.

In one embodiment, the one or more conductive components is disposed over two or more planes (sometimes referred to herein as “layers”) and the two or more planes may or may not be flat. For example, the planes may be warped and/or may have some hills and troughs. Preferably, the two or more planes are spaced apart and do not intersect with one another. Further, the spacing between adjacent planes may vary depending on the target frequency or frequencies of the antenna 100.

The substrate 150 may preferably be a PCB, which may or may not be flexible. In an alternative embodiment, the substrate 50 is a molded interconnect device (“MID”). Other substrates may be used, such as, for example, glass, plastic, and the like.

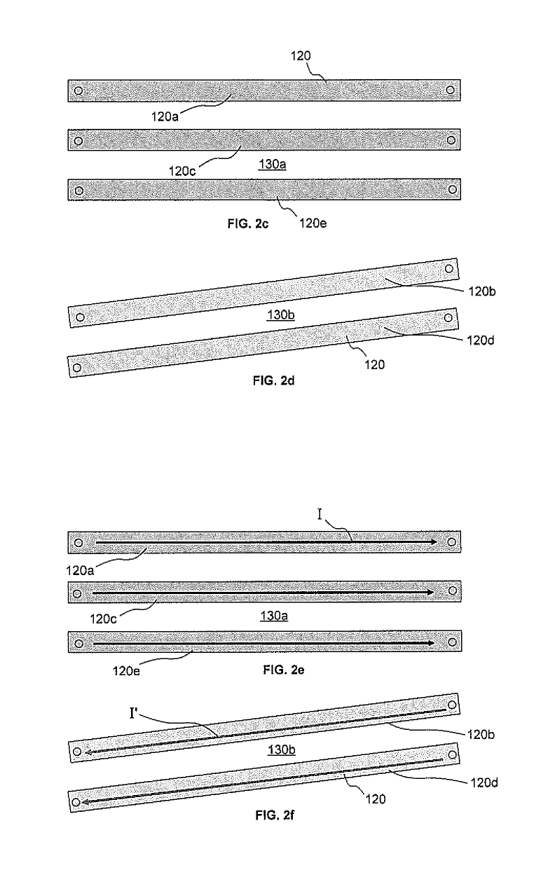

In one embodiment, there is provided an impedance matching “zone” 2 in the antenna. The impedance matching zone may comprise a capacitor 2, operatively connected to the conductive components. The capacitor may in some embodiments comprise a capacitive strip 2, adhered, attached or integral to the substrate, as shown in FIG. 3. In some embodiments, capacitors 2 exhibiting a low equivalent series resistance (ESR) may be used.

It is preferred to minimize the power used by capacitors in tuning the frequency, as power requirements and limits are low in various commercial embodiments. It is in some embodiments advantageous to minimize power used in tuning to maintain maximal transmission distance while minimizing losses due to resistance.

In embodiments where the capacitor is a capacitive strip 2, the antenna 200 has a total length and the strip has a strip length. Particular designs will require particular balance between capacitance, frequency, resistance, and available power to achieve desired transmission strength and levels of tuning. It may in some embodiments be preferable to provide the capacitor (e.g., the strip 2) integral to the substrate 50 and/or conductive components, as doing so minimizes assembly, potential for breakdown, and diminishes chances of overload. The capacitor may also be provided in line with the conductive components and/or in series therewith. In other embodiments, the capacitor may be provided between segment (e.g., between a pair of the segments, each provided in line with a different on of the planes. The relative proportions of components will in some embodiments be a function of design environment and performance requirements, with disclosed antenna configurations being suited to optimize accordingly.

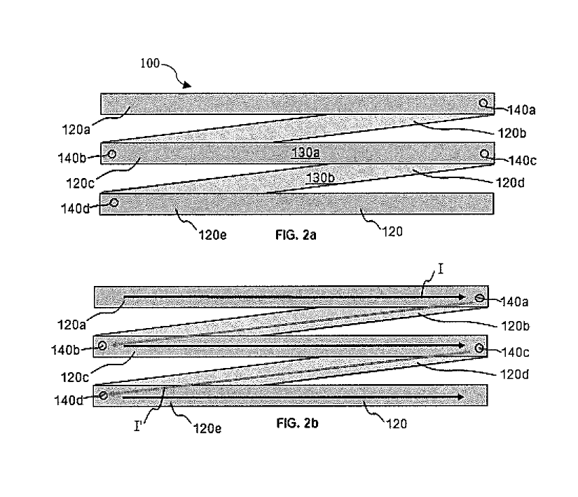

In a further embodiment, and with reference to FIG. 2, the conductive component 120 comprises a plurality of segments 120a to 120e and the conductive component has a total length which is the combined length of all of the segments. In a still further embodiment, some segments 120a-e are situated on a first plane 130a and each pair of adjacent segments on the first plane 130a are connected by a segment situated on another plane 130b. In the illustrated embodiment, segments 120a, 120c, and 120e are situated on the first plane 130a, and segments 120b and 120d are situated on a second plane 130b. Segments 120a and 120c are connected by segment 120b, and segments 120e and segments 120e are connected by segment 120d.

The segments on each plane may not be in physical contact with one another on that plane but adjacent segments may be electrically connected via another plane. For example, in FIG. 2, segments 120a, 120c, and 120e are not connected to one another on the first plane 130a but are electrically connected via the second plane 130b. Similarly, segments 120b and 120d are not connected to each other on the second plane 130b but are electrically connected via the first plane 130a.

Alternatively or additionally, segments on one plane are disposed substantially parallel to one another and in substantially the same direction as one another. For example, in the illustrated embodiment, segments 120a, 120c, and 120e are substantially parallel to one another and extend in substantially the same direction as one another. Similarly, segments 120b and 120d are substantially parallel to each other and extend in substantially the same direction as each other. However, segments 120a, 120c, and 120e on the first plane are not parallel to segments 120b and 120d on the second plane. Therefore, the current directions (notionally shown as I and I′) in the conductive component in the first and second planes, respectively, are each substantially parallel and in the same direction on the same plane 130a, 130b, but not parallel nor in the same direction relative to the other plane.

The number of planes 130a, 130b may vary from application to application, based on a number of factors including, available power, component resistance, desired level of inductance, desired signal strength, desired signal direction, and the size and geometry of the implementation environment. Wave coupling of multiple planes of componentry aids in achieving desired inductance with limited and often specified levels of power (e.g., in a given implementation environment, only a certain quantity of electrical power may be available and other parameters may have to be adjusted to meet performance requirements), resistance and impedance matching (critical to signal reception) also with magnetic loop behaviour properties.

With reference to FIGS. 1 and 2, for the same total length of conductive component, it can be seen that the configuration of the conductive component 120 of the present invention takes up less two dimensional area than that of the same length in prior art antennas. In other words, by disposing segments of the conductive component on two or more planes, more length of the conductive material can be packed into the same two dimensional area than the prior art configuration.

Advantageously, magnetic coupling of segments on different planes serves to provide increases in overall inductance that are beyond merely additive. In some embodiments, and preferably, at least 50% of the plurality of segments are magnetically coupled to at least one other segment. Good magnetic coupling may be achieved by disposing the plurality of segments substantially parallel to one another in substantially the same direction as one another on one plane, as shown, for example in FIG. 2. In another embodiment, at least 50% of the magnetic coupling may be achieved by situating the plurality of segments relative to one another on more than one plane. In a further embodiment, good magnetic coupling may be achieved by situating the plurality of segments on two or more spaced-apart but nearby planes, with current flowing in substantially the same direction in the segments on the two or more planes.

In one embodiment, each pair of adjacent segments on one plane is connected by another segment on another plane through a conductive. The conductive element may comprise multiple connections at a single site, with a view to maintaining current flow direction, with minimized resistance. Conductive element may comprise, for example, copper wires, or via-holes (as described herein).

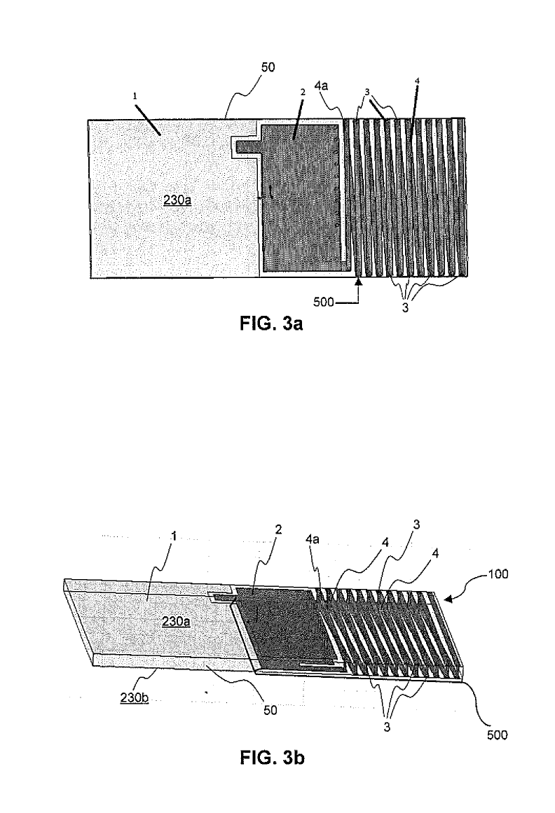

As will be appreciated by one skilled in the art, via-holes are commonly drilled or otherwise punctured or bored (including by laser) through a medium (e.g., a PCB) and plated with a conductive metal or coating. In some instances, via-holes may be plated or filled with copper and may be provided with a surface coating of, for example, lead free hot air solder leveling (HASL) coating. Other conductive materials suitable for use include, for example, gold, or other materials that minimally oxidize over time. The conductive element may comprise a clip having a first leg and a second leg and a gap defined therebetween for accommodating one or more of a portion of the substrate and a portion of one or more of the segments. The first leg contacts the first segment and the second leg contacts the second segment to connect the first segment and the second segment. Connections may be in place between adjacent ones of multiple planes, as shown in FIGS. 2-9. The incorporation of multiple plane designs serves to lower resistance, and increases inductance by wave coupling to provide for inductance of a magnitude greater than the mere sum of the inductances of the segments in each plane.

For example, as shown in FIG. 2, segments 120a and 120c on plane 130a are electrically connected by segment 120b on plane 130b by vias 140a and 140b.

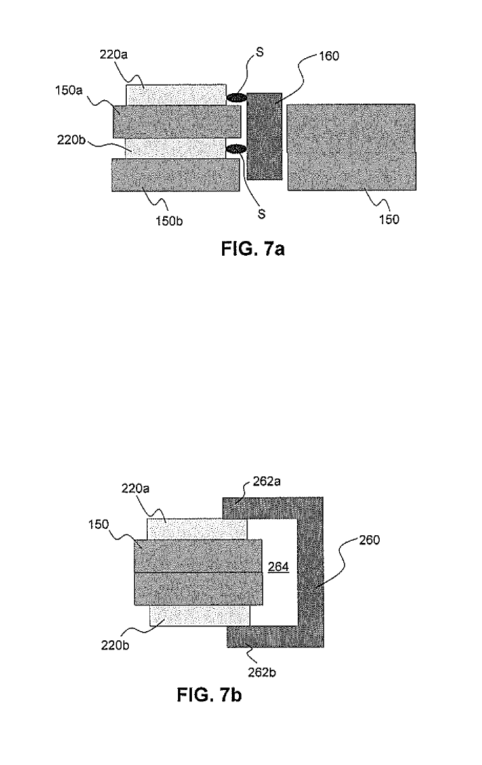

In addition to vias, there are other possible ways to electrically connect a segment on one plane to another segment on another plane. For example, with reference to FIG. 7a, a first segment 220a of a conductive component of the antenna is situated on a first substrate layer 150a of a substrate 150 and a second segment 220b of the conductive component is situated on a second substrate layer 150b of substrate 150. Alternatively, the second substrate layer 150b may be omitted and the second segment 220b may be disposed on a surface of the first substrate layer 150a opposite that of the surface on which the first segment 220a is disposed. As such, segment 220a is on one plane and segment 220b is on another plane, and segments 220a and 220b are separated, for example by substrate layer 150a. Segment 220a is electrically connected to segment 220b by a conductive strip 160. In a preferred embodiment, conductive strip is not situated on either plane and is separate from the substrate layers 150a, 150b. Segment 220a is soldered to the conductive strip at one location and segment 220b is also soldered to the conductive strip at one location, thereby electrically connecting segments 220a and 220b via the conductive strip. The solder is denoted by the reference letter “S” in FIG. 7a.

In another sample embodiment, as shown in FIG. 7b, segments of the conductive component on different planes may be connected by the first segment 220a of the conductive component is disposed on a first surface of substrate 150. The second segment 220b is disposed on a second surface of the substrate that is distinct from the first surface. In one embodiment, as illustrated in FIG. 7b, the second surface is a surface that is facing the opposite direction as first surface. In one embodiment, the substrate 150 comprises two sheets of PCB, each sheet having a top surface with a segment disposed thereon and a bottom surface without any segments. The two sheets are placed together with the bottom surfaces facing and in contact with one another, and with the top surfaces facing outwards.

In a sample embodiment, as illustrated in FIG. 7b, the first segment 220a and the second segment 220b are electrically connected by a conductive clip 260. Conductive clip 260 has a first leg 262a and a second leg 262b and a gap 264 therebetween for accommodating a portion of the substrate 150 and/or segments 220a, 220b. For example, conductive clip 260 may be C-shaped or U-shaped. The first leg 262a is in contact with segment 220a and the second leg 262b is in contact with segment 220b, thereby electrically connecting the two segments via the conductive material of clip 260. Preferably, clip 260 is only in contact with the segments and is not in contact with substrate 150.

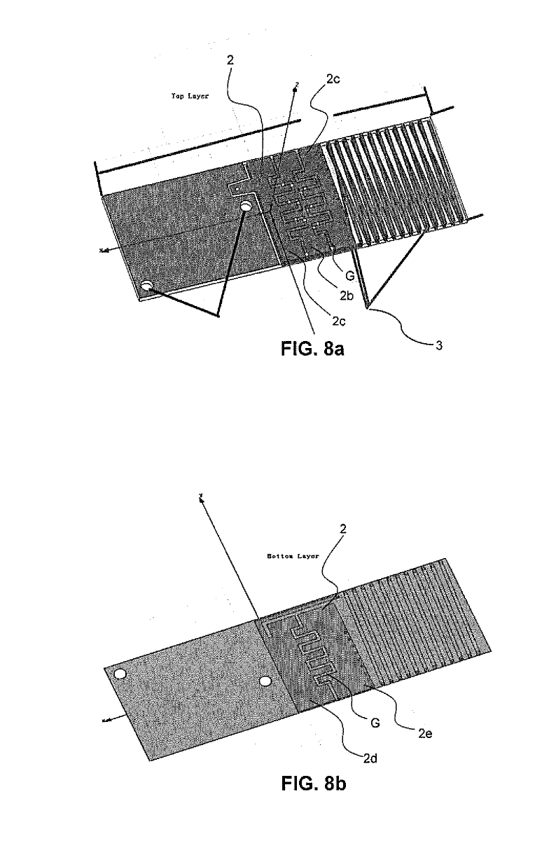

FIG. 3 shows another embodiment of an antenna of the present invention. The antenna has a conductive component comprising a plurality of antenna segments 4 and a capacitive strip 2. The antenna has a non-conductive component comprising a ground plane 1 for a transceiver circuits 1 or a battery. See, for example the transceiver shown in FIG. 8A. Various embodiments may be provided wherein the transceiver is formed integrally with the substrate and/or operatively attached thereto.

The conductive and non-conductive components are fabricated on a double-layer substrate 50. In one embodiment, ground plane 1 is printed on an upper surface 230a of substrate 50. Preferably, antenna segments 4 are made of a flexible conductive material, while substrate 50 is made of a somewhat rigid non-conductive material.

One end of a first antenna segment 4a of the plurality of segments is connected to the capacitive strip 2. About half of the segments are situated on the upper surface 230a and the remaining segments are situated on a lower surface 230b of the board, whereby the conductive segments on the lower surface connect to the conductive segments on the upper surface through the board in an over-locking pattern. The lower surface faces substantially the opposite direction as the upper surface.

In one embodiment, substrate board 50 has a plurality of via-holes 3 extending between the upper surface and the lower surface for electrically connecting the segments on the upper surface 230a to those on the lower surface 230b, such that adjacent segments on the upper surface are electrically connected by a segment on the lower surface, and vice versa.

As with connections discussed above, there are various ways to electrically connect a segment on the upper surface to a segment on the lower surface. For example, a conductive material is inserted into the via-hole 3 and extends the entire length of the via-hole. Each segment is electrically connected to the conductive material by, for example, soldering. In another example, a conductive coating is provided on the inner surface of via-hole 3 and the coating extends from one end to the other end of the via-hole. Each segment is electrically connected to the conductive coating by, for example, by soldering.

When the plurality of segments on the upper surface are electrically connected to the plurality of segments on the lower surface, as described above, current can flow through all the segments and connections on a path forming a pattern (e.g., helical), thereby providing an antenna effect.

The purpose of having antenna segments on different planes is to provide more antenna length and to connect the magnetically coupled antenna segments on the first plane (which provides advantages, as discussed).

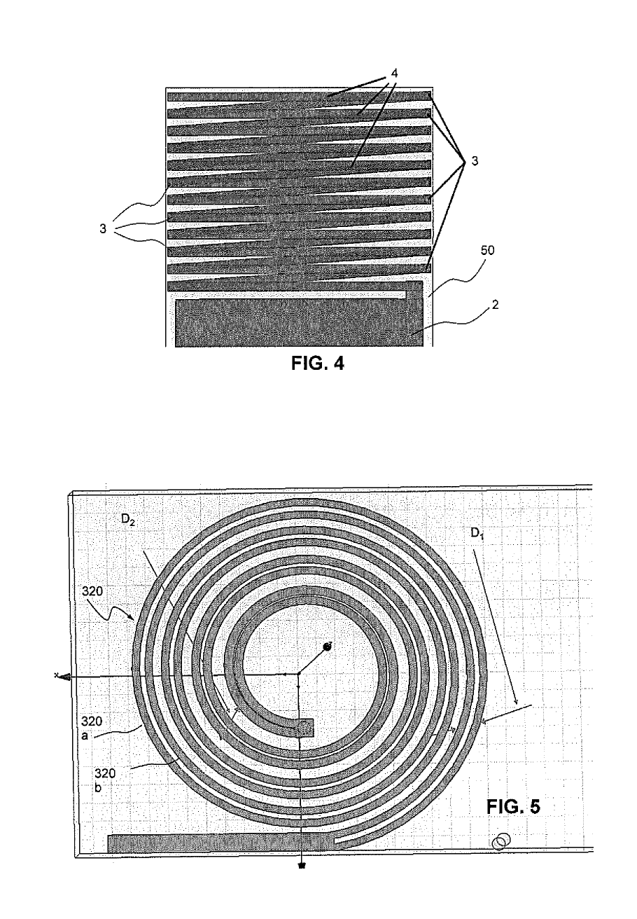

In another embodiment, the plurality of antenna segments form a looped, winding, and/or helical electrical path. With reference to FIG. 5, the conductive component 320 of an antenna device comprises a first antenna segment 320a and a second antenna segment 320b. Both segments 320a, 320b are situated on the same plane. The first segment 320a is in a two dimensional spiral pattern. The second segment 320b is spaced apart from the first segment and follows substantially the same pattern as the first segment, thereby forming a double-line two dimensional spiral (“double spiral”).

The distance between the first and second segments at about the same location of the same layer of the double spiral is denoted by the reference letter “D₁”. The distance between the first segment on one layer of the double spiral and the second segment at about the same location but on an adjacent layer of the double spiral is denoted by the reference letter “D₂”. Preferably, distance D₁ is substantially consistent throughout the double spiral. The value of distance D₁ may be selected to maximize good electromagnetic coupling between the first segment and the second segment. The value of distance D₂ may be selected to minimize bad electromagnetic coupling between the first segment and the second segment.

One or both of the first and second segments 320a, 320b are connected to a capacitive strip (not shown). Current in the first and second segments flows in the same direction (i.e. clockwise or counter-clockwise). Together, the first antenna segment and the second antenna segment form a kind of dipole antenna, which each segment being one leg of the dipole.

In a further embodiment, multiple conductive components with a plurality of antenna segments are provided on the same substrate. In a still further embodiment, at least two conductive components are situated on the same plane. In an additional or alternative embodiment, at least two conductive components are situated on different planes. In a still further embodiment, at least 50% of the plurality of segments of at least one of the conductive components are disposed substantially parallel to one another in substantially the same direction as one another.

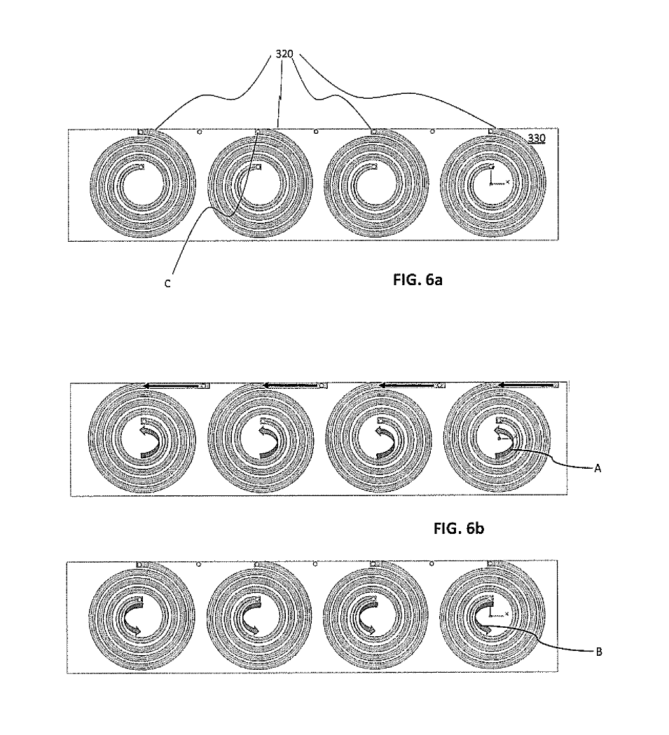

For example, with reference to FIG. 6a, several conductive components 320 are situated on the same plane 330. Each conductive component is a double spiral having a first antenna segment and a second antenna segment, as described above with respect to FIG. 5. With reference to FIG. 6b, the spirals within the same layer and/or different layers are connected in such a way that the current direction in each spiral is synchronized with the others. The conductive components are electrically connected to a capacitive strip (not shown) via line C. Current flows in the same direction along the path (shown notionally in FIGS. 2-9), for example, from the power source (e.g., a battery, base station, door control (be it automotive, residential/commercial, or other commercial environments)). For example, current in line with one plane may flow inward (i.e., from an outer radius to an inner radius) in a spiral and then through a conductive element to the segments aligned with the adjacent, parallel plane, as shown in FIGS. 5-6, and may then flow in the same direction but along the spiral path from the inner radius to the outer radius, and so on (thereby maintaining coupling).

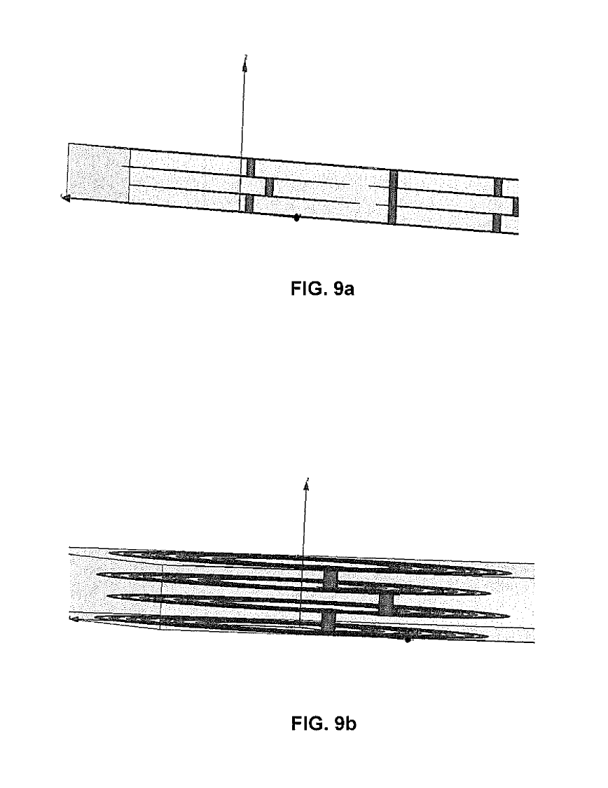

In a further embodiment, with reference to FIGS. 9a and 9b, the antenna may comprise multiple planes, each having multiple conductive components, such as double spirals and/or multiple substantially parallel antenna segments, as discussed above. For example, the antenna of the present invention may have multiple planes of the multiple conductive component configuration shown in FIG. 6a, The spacing between planes, with each plane having one or more conductive components, may be selected to maximize good electromagnetic coupling between the conductive components.

In one embodiment, the conductive component is attached to the non-conductive component in one or more planes that are discreet from the plane(s) of the antenna segment(s) to form one or more electromagnetic shielding segments such that when viewed in a direction not parallel to the one or more planes, the shielding segment(s) overlap with at least 50% of the antenna segment(s).

The disclosed antenna herein allows impedance matching without using the lumped elements. The antenna disclosed herein may allow impedance matching by capacitive shielding (i.e. using the capacitive strip to shield the transceiver circuit). The present invention makes it easy to integrate the transceiver circuit, the battery, the sensor circuit and the antenna into a small area for the short-range devices.

In prior art antenna designs, it is difficult to match the antenna without the lumped elements. However, these extra lumped elements used in the matching circuit tend to cause additional loss and degrade the antenna performance. The disclosed antenna eliminates the need to include lumped elements by connecting the capacitive strip to the antenna segment monopole (e.g. the first antenna segment 4a in FIG. 3) instead of the ground, which enlarges the matching area which may improve the antenna matching.

The capacitive strip 2 does not serve as a part of the ground plane 1, but rather as a part of the monopole antenna. Since the capacitive strip is connected to the antenna segment monopole, the signal line from the ground plane is connected to the shield area instead of directly to the antenna segments. This makes the shield area one of the antenna segments. The configuration of the antenna segments determines the center frequency and the impedance matching. The resonant frequency can be controlled by adjusting the total length of the antenna segments.

In order to minimize the “footprint” (Le. two dimensional surface area on the substrate) of the plurality of antenna segments of a preselected total length, the plurality of antenna segments can be rendered into a reinforced pattern consisting of two or more layers of antenna segments forming a repeating or mirroring geometric pattern or two or more substantially parallel, side-by-side antenna segments forming a pattern on one or more layers, examples of which are described above. Whatever the reinforced pattern is, one or more of the plurality of antenna segments can be connected to a capacitive strip. While the examples provided herein are described to be preferably used in connection with a capacitive strip, it can be appreciated that other similar mechanisms (e.g. lumped elements) can be used in lieu of the capacitive strip and/or capacitor (e.g., low ESR).

In the sample embodiment illustrated in FIG. 3, the plurality of antenna segments form a reinforced pattern consisting of a double layer zigzagging line. In this embodiment, the segments on the upper surface are parallel to one another. Similarly, the segments on the lower surface are parallel to one another. Each segment on each surface is connected to at least one segment of the other surface through vias. In most cases, each segment on each surface is connected to two segments of the other surface, one at each end. The segments on the upper surface are not parallel to the segments on the lower surface, such that an angle is defined between every two connected segments about the connection point (i.e. vias).

Having the segments run parallel to one another in the same direction on each plane helps minimize losses due to weak magnetic coupling that may result from radiation cancellation in some configurations.

In a preferred embodiment, the antenna will be capable of sending and receiving a bandwidth of either 315 MHz or 433 MHz; however, as noted herein, other bandwidths may be used (e.g., 125 kHz).

In a further embodiment, the plurality of antenna segments may have a reinforced pattern consisting of more than two planes of segments. While a zigzagging pattern and a double spiral pattern are shown in the figures, other reinforced patterns are possible.

In another embodiment, the antenna of the present invention may be fabricated on a single lawyer or multilayer substrate board (e.g., two layers). The antenna has a plurality of antenna segments with a reinforced pattern of a double spiral (as shown for example in FIG. 5), a capacitive strip, and a ground plane for the transceiver circuits or the battery. The ground plane is printed on the front side of the substrate board. The double spiral is connected to the capacitive strip. In this embodiment, the capacitive strip has two layers, one of which is connected to the group plane and the other of which is connected to the rest of the antenna.

The configuration of the double spiral determines the center frequency and the impedance matching. The resonant frequency can be controlled by adjusting the total length of the antenna segments. The number of layers (or “loops”) in the double spiral serves to magnify the signals sent and/or received thereby.

The double spiral may minimize the “footprint” of the conductive component while maintaining the signal strength of the antenna. One or more double spirals may be placed on one plane and one or more double spirals may be placed on another plane. More than two planes with double spiral(s) are possible. The double spiral(s) on each plane is placed such that the double spiral(s) is magnetically coupled to the double spiral(s) of the other plane. Furthermore, in order to maximize the signal strength of each double spiral, each double spiral is composed of magnetically coupled antenna segments running alongside each other. The individual spiral thus serves as its own discreet mini-antenna, which is connected in parallel to the capacitive strip (or capacitor).

An area on top of the capacitive strip can accommodate a battery, other power source, or sensor circuit if necessary to save space. In prior art antennas, lumped elements are thick and bulky so it is not easy to place another PCB layer on top of the lumped elements. Since the disclosed antenna provides an antenna without lumped elements, the antenna has more space to accommodate other equipment such as an additional substrate, transceiver circuit, battery, sensor circuit, etc. The present invention allows the conductive component(s) to be situated somewhat close to one another and/or other equipment in a compact space.

In a further sample embodiment, as shown in FIGS. 8a and 8b, the capacitive strip 2 is divided into several sections 2a to 2e. Sections 2a to 2c are situated on an upper surface and sections 2d and 2e are situated on a lower surface. Each section may be connected to an antenna monopole or to each other, in series or in parallel. Adjacent sections are divided by a gap G which may have a particular line shape. The shape of the line may be varied and the total impedance of the antenna may be varied by varying the line shape of gap G. Dividing capacitive strip 2 into two or more sections and/or varying the line shape of gap G provides the antenna more flexibility to match impedance and/or adjust the frequency of the antenna without increasing the two dimensional area required for the antenna components.

The upper surface and the lower surface of the capacitive strip do not necessarily have to be of the same or similar size. Further the sections of the capacitive strip do not necessarily have to be of the same or similar size and/or shape. In a further embodiment, one or more of the sections may comprise smaller subsections. The sections and/or subsections may be connected in various configurations to achieve the desired impedance matching, i.e. how and which of: the sections are connected to one another; the electronic circuitry is connected to the section(s); and/or the section(s) are connected to the rest of the antenna. The shape of each section may also be varied to achieve the desired impedance matching.

Looking next to FIG. 3b, there is shown a further embodiment wherein a ferrite sheet 500 is provided substantially adjacent the substrate 50. In some embodiments, a non-conducive material may be interposed between the ferrite sheet 200 and the substrate 50. The ferrite sheet 500 serves to direct away from it and amplify any signal emulating from the antenna.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field,” such claims should not be limited by the language under this heading to describe the so-called technical field. Further, a description of technology in the “Background” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

All of the systems and methods disclosed and/or claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure.

1. An antenna comprising:
a substrate comprising two or more regions;
one or more conductive components disposed on the substrate, over two or more of the regions;
wherein the regions are oriented on or relative to different planes and wherein the planes are substantially spaced from one another; and
wherein the conductive components situated on a first one of the planes are operatively magnetically coupled to non-conductive components situated on an other of the planes.

2. The antenna according to claim 1, wherein the antenna further comprises an impedance matching zone comprising a capacitor operatively connected to the substrate.

3. The antenna according to claim 1, wherein the conductive components comprise a plurality of segments, wherein each of the segments is electrically connected to at least another of the segments and the conductive components have a total length which is the combined length of the segments.

4. The antenna according to claim 3, wherein one or more of the segments are situated on a first one of the planes and connected to one of the segments situated on an other of the planes.

5. The antenna according to claim 4, wherein the segments on the first one of the planes are oriented in substantially the same direction as one another such that current may flow therethrough in the same direction.

6. The antenna according to claim 3, wherein a first one of the segments is provided on the first one of the planes and a second one of the segments is provided on the other one, and wherein the first and second ones of the segments are electrically connected by a conductive element.

7. The antenna according to claim 6, wherein the substrate has a first surface and a second surface opposite thereto, and the other one of the planes is substantially aligned with the second surface, and the first one of the planes is substantially aligned with the first surface.

8. The antenna according to claim 6, wherein the conductive element is not situated on either of the planes and is not integral to the substrate.

9. The antenna according to claim 6, wherein the conductive element comprises one of more of a conductive strip and a conductive clip.

10. The antenna according to claim 1, wherein the non-conductive components are adapted for connection with one or more of a transceiver circuit and a power source.

11. The antenna according to claim 3, wherein the substrate has defined therein a plurality of via-holes extending between an upper surface and a lower surface thereof through which via-holes the segments on the upper surface are electrically connected to those on the lower surface or on an adjacent one of the planes.

12. The antenna according to claim 6, wherein the segments and the conductive elements collectively form an electrical path defining a pattern, and wherein the antenna is adapted for current flow along the path in a direction.

13. The antenna according to claim 12, wherein the pattern comprises a two dimensional spiral pattern.

14. The antenna according to claim 13, wherein the second segment is spaced from the first segment and provided substantially within the pattern.

15. The antenna according to claim 3, wherein the conductive components comprises a plurality of the segments provided in substantial alignment with a single one of the planes.

16. The antenna according to claim 3, wherein the planes comprises multiple planes, each of the planes having substantially aligned therewith one or more of the conductive components.

17. The antenna according to claim 12, wherein the pattern is substantially repeating on adjacent ones of the planes.

18. The antenna according to claim 12, wherein the pattern comprises a zigzagging pattern.

19. The antenna according to claim 12, wherein the antenna further comprises the segments provided in a double spiral pattern; a capacitive strip having two layers, wherein one of the layers is connected to the non-conductive components, wherein the non-conductive components comprises a ground plane printed on a front side of the substrate for connection with one or more of a transceiver circuit or a battery.

20. The antenna according to claim 12, wherein the pattern comprises a plurality of double spirals, and wherein each of the double spirals is aligned with and magnetically coupled to the double spiral of another plane.

21. The antenna according to claim 12, wherein each pattern is composed of magnetically coupled pairs of the segments aligned substantially parallel to each other and in the same direction along the path.

22. An antenna for transmitting a signal, the antenna comprising:
a. a substrate comprising two or more regions;
b. one or more conductive components disposed on the substrate, over two or more of the regions; wherein the regions are each oriented in substantial alignment with different planes and wherein the planes are substantially spaced from and substantially parallel to one another;
c. a power source for driving a current in a direction along an electrical path comprised of the conductive components and having a pattern notionally collectively defined by portions of each of the planes and conductive elements interposed between the regions aligned with the planes; and, wherein the conductive components oriented on each of the planes are magnetically coupled with the conductive components on at least an adjacent one of the planes.

23. The antenna according to claim 23, further comprising a ferrite sheet interpose a non-conductive component substantially contiguous with and shaped to a surface of the substrate to prevent transmission of the signal towards the sheet.
